(19) United States
(12) Patent Application Publication
(10) Pub. No.: US 2025/0033999 A1
(43) Pub. Date: Jan. 30, 2025

(54) WARM ULTRAPURE WATER PRODUCTION DEVICE

(71) Applicant: KURITA WATER INDUSTRIES LTD., Tokyo (JP)

(72) Inventors: Junya HIRAYAMA, Tokyo (JP); Masahiro OKAWARA, Tokyo (JP)

(73) Assignee: KURITA WATER INDUSTRIES LTD., Tokyo (JP)

(21) Appl. No.: 18/711,100

(22) PCT Filed: Sep. 14, 2022
(86) PCT No.: PCT/JP2022/034394

§ 371 Date: May 16, 2024

(30) Foreign Application Priority Data
Dec. 3, 2021 (JP) 2021-197028

(51) Int. Cl. C02F 1/00; C02F 1/02; C02F 1/44; C02F 103/04

(52) U.S. Cl. CPC C02F 1/008; C02F 1/02; C02F 1/444; C02F 2103/04; C02F 2209/02; C02F 2209/42; C02F 2303/10

(57) ABSTRACT

Ultrapure water from a subsystem 4 is fed to a use point 14, via a first heat exchanger 6, a second heat exchanger 10, and a UF membrane separation device 12. The ultrapure water returned from the use point 14 is introduced into a storage tank 16 through a pipe 7. In response to fluctuation of the flowrate of the returned ultrapure water, heated primary pure water is introduced into the storage tank 16 through a pipe 22, and warm water at a prescribed temperature is stored in the storage tank 16 so as to attain a prescribed water level. The warm water in the storage tank 16 is supplied at a fixed flowrate through a heat source fluid path of the first heat exchanger 6.

### TECHNICAL FIELD

The present invention relates to an ultrapure water production device, and particularly to a warm ultrapure water production device that heats ultrapure water from a subsystem (secondary pure water production device) with a heat exchanger and supplies the same to a use point as warm ultrapure water.

### BACKGROUND ART

Ultrapure water used as semiconductor cleaning water is produced by treating raw water (industrial water, city water, well water, etc.) with an ultrapure water production device that has a pretreatment system, a primary pure water production device, and a subsystem (secondary pure water production device).

The pretreatment system including coagulation, pressure flotation (sedimentation), filtration (membrane filtration) devices, and the like removes suspended solids and colloidal substances from raw water. Furthermore, in this process, polymeric organic substances, hydrophobic organic substances, and the like may be removed.

The primary pure water device includes a heat exchanger, a reverse osmosis membrane treatment device (RO device), an ion exchange device (mixed bed, 4-bed 5-tower, etc.), an ion exchange device, a deaeration device, and the like. A primary pure water production device removes ions and organic components from raw water. It is noted that the higher the temperature of water, the lower the viscosity and the higher the permeability of the RO membrane. For this reason, a heat exchanger is provided to the pre-stage of the reverse osmosis membrane treatment device and heats the water so that the temperature of the water supplied to the reverse osmosis membrane treatment device is equal to or higher than a prescribed temperature. The reverse osmosis membrane treatment device removes salts as well as ionic and TOC. The ion exchange device removes salts and inorganic carbon (IC) as well as TOC components adsorbed or ion-exchanged by the ion exchange resin. The deaeration device removes inorganic carbon (IC) and dissolved oxygen.

The primary pure water produced by the primary pure water production device is fed to the subsystem. This subsystem includes a sub tank (pure water tank), a low-pressure ultraviolet oxidation device (UV device), an ion exchange device, etc. In the low-pressure ultraviolet oxidation device, TOC is decomposed into organic acids and even CO₂ using 185 nm ultraviolet light emitted from a low-pressure ultraviolet lamp. The organic matter and CO₂ produced by the decomposition are removed by the ion exchange device in the latter stage.

Ultrapure water from the subsystem is heated to about 70 to 80° C. in a heat exchanger and supplied to the use point.

FIG. 2 is a system diagram illustrating the ultrapure water production device described in Patent Document 1. It is noted that, although the water temperature is illustrated in the following description, each water temperature is an example and does not limit the present invention at all.

Primary pure water at about 25° C. from the primary pure water device is introduced into a subsystem 4 via a pipe 1, a sub tank 2, and a pipe 3, and ultrapure water at about 20 to 30° C. is produced. The produced ultrapure water flows in a pipe 5, a first heat exchanger 6, a pipe 9, and a second heat exchanger 10 sequentially and is heated by the first heat exchanger 6 to 30 to 50° C., for example, about 42° C., and by the second heat exchanger 10 to 65 to 85° C., for example, about 75° C., and the water is fed to the use point 14 by a pipe 11, a UF membrane separation device 12, and a pipe 13 as warm ultrapure water. The UF membrane separation device 12 is provided immediately before the use point.

The returned warm ultrapure water (returned water) of about 75° C. from the use point is introduced into the heat source fluid path of the first heat exchanger 6 via a pipe 7. This returned warm ultrapure water exchanges heat with the ultrapure water from the subsystem 4 in the first heat exchanger 6 to lower the temperature to about 40° C., and then is sent to the sub tank 2 by a pipe 8. Concentrated water from the UF membrane separation device 12 is introduced into the pipe 7 via a pipe 15.

Steam or warm water is supplied to the heat source fluid path of the second heat exchanger 10.

### PRIOR ART DOCUMENT

### Patent Document

Patent Document 1: Japanese Patent Application Laid-Open (JP-A) No. 2018-43229.

### SUMMARY

### Problems to be Solved by the Present Invention

In the conventional warm ultrapure water production device described above, the temperature of the ultrapure water from the subsystem 4 is almost constant, but the temperature of the ultrapure water fed from the first heat exchanger 6 to the second heat exchanger 10 fluctuates. As a result, the temperature of the warm ultrapure water fed to the use point 14 via pipes 11 and 13 may fluctuate significantly and deviate from the guaranteed temperature value. The main reason for this is that the amount of the returned ultrapure water from the use point 14 fluctuates greatly, which causes a significant fluctuation in the temperature of the ultrapure water flowing out from the first heat exchanger 6 to the pipe 9. As a result, the temperature of the ultrapure water flowing out from the second heat exchanger 10 to the pipe 11 fluctuates. In addition, when steam is used as the heat source fluid of the second heat exchanger 10, the temperature response is too good due to the high heat transfer coefficient, and the temperature of the ultrapure water may cause hunting. Furthermore, when warm water is used as the heat source fluid of the second heat exchanger 10, a delay in temperature response occurs due to the low heat transfer coefficient, and the temperature of the ultrapure water may deviate from the guaranteed temperature value.

An object of the present invention is to provide a warm ultrapure water production device that may reduce the temperature fluctuation range of warm ultrapure water fed to a use point.

### Means for Solving the Problems

The warm ultrapure water production device in one aspect of the present invention includes: an ultrapure water production portion, provided with a primary pure water production device and a secondary pure water production device; an ultrapure water supply pipeline, supplying ultrapure water from the ultrapure water production portion to a use point; a first heat exchanger provided in the ultrapure water supply pipeline, through which returned water that is not used at a use point is supplied as heat source water to a heat source fluid path via a returned water line; returned water returning pipe, returning the returned water that has passed through the heat source fluid path of the first heat exchanger to the ultrapure water production portion; and a heating means, further heating ultrapure water heated by the first heat exchanger. A warm pure water supply mechanism that supplies warm pure water in a midway of the returned water line is provided in a warm ultrapure water production device in which ultrapure water heated by the heating means is supplied to a use point.

In one aspect of the present invention, a storage tank is provided in the returned water line, and the storage tank is provided with the warm pure water supply mechanism.

In one aspect of the present invention, the heating means is a second heat exchanger using steam or warm water as a heat source.

In one aspect of the present invention, the warm pure water supply mechanism includes a pure water supply pipeline communicating with a pure water supply source and a third heat exchanger provided in the pure water supply pipeline.

In one aspect of the present invention, a temperature sensor that measures a temperature of water stored in the storage tank and a control means that controls the warm pure water supply mechanism so that a temperature detected by the temperature sensor is a prescribed temperature are further provided.

In one aspect of the present invention, the control means controls a supply amount of warm pure water supplied from the warm pure water supply mechanism so that a water level of the water stored in the storage tank falls within a prescribed range.

In one aspect of the present invention, a water feeding means that feeds the water stored in the storage tank at a fixed flowrate to the heat source fluid path of the first heat exchanger is further provided.

In one aspect of the present invention, the returned water returning pipe from the heat source fluid path of the first heat exchanger is provided with a cooling means that cools returned water.

### Effects of the Invention

In the ultrapure water production device of the present invention, since a storage tank is provided in the returned water line, and the storage tank is supplied with the warm pure water, even if the flowrate of the returned ultrapure water from the use point fluctuates, water at a substantially constant temperature is passed through the heat source fluid path of the first heat exchanger 6 at a substantially constant flowrate. The temperature of the ultrapure water produced by the secondary pure water production device is substantially constant, and the amount of ultrapure water produced is also substantially constant. As a result, the temperature of the ultrapure water fed from the first heat exchanger to the heating means, e.g., the second heat exchanger, is substantially constant, so the temperature of the ultrapure water fed from the heating means to the use point is also substantially constant, and the deviation from the target temperature is extremely small.

### BRIEF DESCRIPTION OF THE DRAWINGS

FIG. 1 is a system diagram of the ultrapure water production device according to the embodiment.

FIG. 2 is a system diagram of the ultrapure water production device according to the conventional example.

### DESCRIPTION OF THE EMBODIMENTS

The ultrapure water production device of the present invention includes an ultrapure water production portion provided with a primary pure water production device and a subsystem (secondary pure water production device) and a heating means that heats the produced ultrapure water.

In a typical case, a pretreatment device is provided to the pre-stage of this primary pure water production device. In the pretreatment device, a pretreatment through filtration of raw water, coagulation sedimentation, microfiltration membrane, and the like is performed and. thereby, suspended substances are removed mainly. The number of fine particles in the water results in usually 103 particles/mL or less by this pretreatment.

The primary pure water production device is provided with a reverse osmosis (RO) membrane separation device, a deaeration device, a regenerative ion exchange device (mixed bed, 4-bed 5-tower, etc.), an electric deionization device, an oxidation device, e.g., an ultraviolet (UV) irradiation oxidation device, and removes most of electrolytes, fine particles, viable bacteria, and the like in the pretreated water. The primary pure water production device includes, for example, a heat exchanger, an RO membrane separation device, a mixed bed ion exchange device, and an RO membrane separation device.

The subsystem includes a sub tank, a feed water pump, a heat exchanger for cooling. a low-pressure ultraviolet oxidation device, a non-regenerative mixed bed ion exchange device, and a membrane filtration device, e.g., an ultrafiltration (UF) membrane separation device, a microfiltration (MF) membrane separation device. However, in some cases, a deaeration device, an RO membrane separation device, and an electric deionization device, may also be provided. In the subsystem, TOC in water is oxidized and decomposed by ultraviolet rays using the low-pressure ultraviolet oxidation device, and oxidative decomposition products are removed by ion exchange.

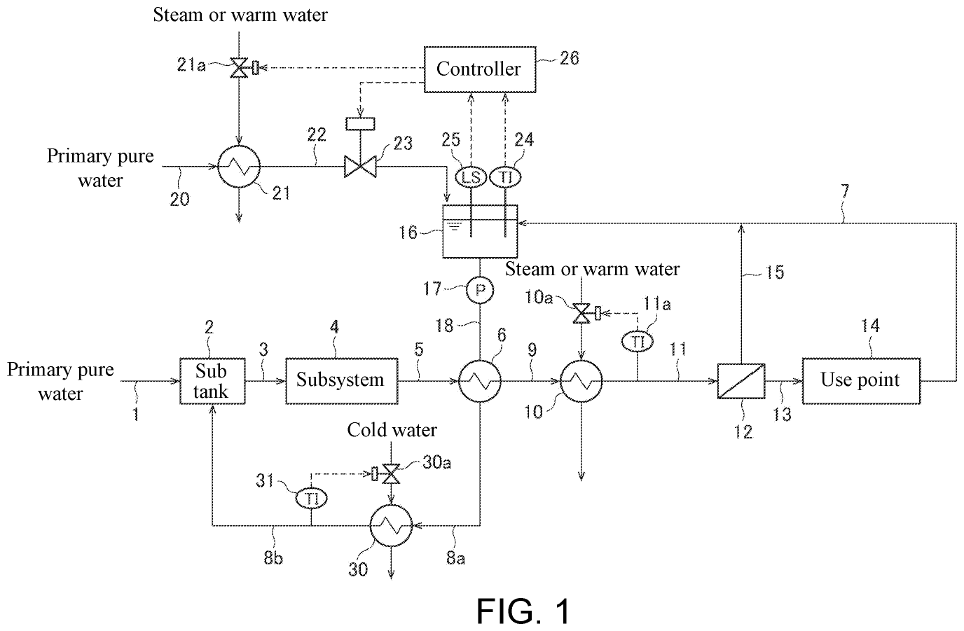

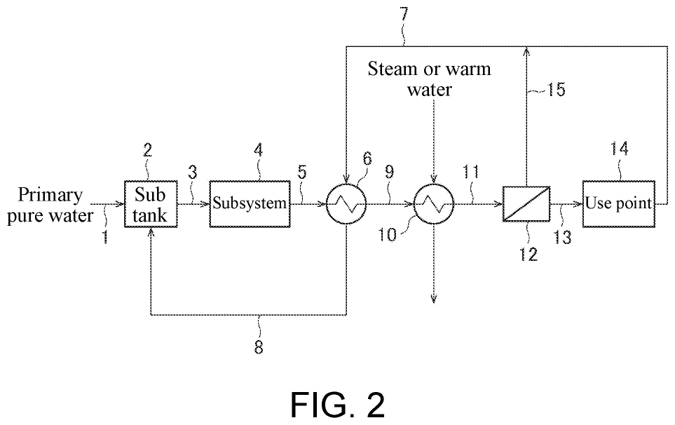

The embodiment of the present invention will be described below with reference to the drawings. FIG. 1 is a system diagram illustrating the warm ultrapure water production device according to the embodiment, and the same parts as in FIG. 2 are given the same reference numerals. It is noted that, although the water temperature is illustrated in the following description, each water temperature is an example and does not limit the present invention at all.

In this embodiment as well, primary pure water of about 25° C. is introduced into the subsystem 4 via a pipe 1, a sub tank 2, and a pipe 3, and ultrapure water of about 30° C. is produced. The produced ultrapure water flows in a pipe 5, a first heat exchanger 6, a pipe 9, and a second heat exchanger 10 sequentially and is heated by the first heat exchanger 6 to about 42° C., and by the second heat exchanger 10 to about 75° C., and the water is fed to the use point 14 via a pipe 11. a UF membrane separation device 12, and a pipe 13 as warm ultrapure water. The UF membrane separation device 12 is provided immediately before the use point 14.

Warm water at 65 to 85° C., for example, about 75° C., is introduced from a storage tank 16 to a heat source fluid path of the first heat exchanger 6 through a pump 17 and a pipe 18. This warm water exchanges heat with the ultrapure water from the subsystem 4 in the first heat exchanger 6 to lower the temperature to about 40° C., and then is sent to the sub tank 2 by pipes 8a and 8b.

Steam or warm water is distributed to the heat source fluid path of the second heat exchanger 10 via a valve 10a. The valve 10a is controlled so that the temperature of the ultrapure water detected by a temperature sensor 11a provided in the pipe 11 is a prescribed temperature (75±1° C. in this embodiment).

In this embodiment, the returned ultrapure water from the use point 14 is introduced into the storage tank 16 via a pipe 7, which forms a returned water line. It is noted that the end of pipe 15 is connected to the pipe 7, and concentrated water from the UF membrane separation device 12 joins therein.

Warm pure water is supplied to the storage tank 16 by a warm pure water supply mechanism. That is, primary pure water from a primary pure water source is passed through a pipe 20 to a third heat exchanger 21 and heated, and then flows into a pipe 22 provided with a valve 23. Steam or warm water from a boiler or the like is supplied to the heat source fluid path of the third heat exchanger 21 via a valve 21a. It is noted that the primary pure water source may be used in combination with the primary pure water device forming the ultrapure water production portion, or may be separate.

The storage tank 16 is provided with a temperature sensor 24 and a water level sensor 25, and the detection signals of the temperature sensor 24 and the water level sensor 25 are transmitted to a controller 26. The controller 26 controls the opening degrees of the valves 21a and 23 so that the water temperature detected by the temperature sensor 24 is the prescribed temperature (set temperature in the range of 65 to 85° C., about 75° C. in this embodiment) and the water level detected by the water level sensor 25 is a prescribed water level.

The returned ultrapure water from the pipe 7 and the warm primary pure water from the pipe 22 are mixed in the storage tank 16, and the water (warm water) at the prescribed temperature is quantitatively supplied to the heat source fluid path of the first heat exchanger 6 via the pump 17 and the pipe 18.

The outflow water from the heat source fluid path of the first heat exchanger 6 is cooled by being passed through a fourth heat exchanger 30 from the pipe 8a that forms the returned water returning pipe, and then introduced into the sub tank 2 via the pipe 8b. Cold water from a cooling tower or the like is passed through the heat source fluid path of the fourth heat exchanger 30 via a valve 30a. A temperature sensor 31 is provided in the pipe 8b, and the amount of cold water supplied to the fourth heat exchanger 30 is controlled so that the water temperature detected by the temperature sensor 31 is the prescribed temperature.

In the warm ultrapure water production device in FIG. 1, in the case that the maximum amount of ultrapure water used at the use point 14 is W (ton/Hr), the actual amount of ultrapure water used at the use point 14 fluctuates in the range of 0 to 100% of W. Normally, ultrapure water is supplied to the use point 14 in an amount larger than W, for example, 120 to 200% of W, 180% in this embodiment, and unused ultrapure water is discharged to the pipe 7.

Further, in the UF membrane separation device 12, about 10% of the W is discharged to the pipe 15 as concentrated water (non-membrane permeated water), and the remainder is fed to the use point 14.

Thus, the subsystem 4 produces ultrapure water with an amount of water that is about 190% (180+10=190%) of W, and sends the same to the pipe 5.

As mentioned above, ultrapure water is supplied to the use point 14 at a flowrate of 180% of W, and since the actual amount of ultrapure water used at the use point 14 fluctuates between 0 and 100% of W, the flowrate of the returned ultrapure water flowing from the use point 14 to the pipe 7 fluctuates in the range of 80 to 180% of W. Since 10%×W non-membrane permeated water from the UF membrane separation device 13 flows into the pipe 7 via the pipe 15, the flowrate of ultrapure water flowing into the storage tank 16 from the pipe 7 fluctuates in the range of 90 to 190% of W.

In this embodiment, the water flowrate from the storage tank 16 to the heat source fluid path of the first heat exchanger 6 is 190% of W. Since the inflow flowrate from the pipe 7 to the storage tank 16 fluctuates between 90 and 190% of W, when the inflow flowrate is a % below 190%, heated primary pure water is supplied from the pipe 22 to the storage tank 16 at a flowrate of (190−a) %×W. At this time, the opening degrees of the valves 21a and 23 are controlled so that the water level in the storage tank 16 falls within a prescribed range and the water temperature in the storage tank 16 falls within a prescribed range.

In this way, even if the flowrate of the returned ultrapure water from the use point 14 fluctuates, water at a substantially constant temperature is passed through the heat source fluid path of the first heat exchanger 6 at a substantially constant flowrate. The temperature of the ultrapure water produced by the subsystem 4 is substantially constant, and the amount of ultrapure water produced is also substantially constant. As a result, the temperature of the ultrapure water fed from the first heat exchanger 6 to the second heat exchanger 10 is substantially constant, so the temperature of the ultrapure water fed from the second heat exchanger 10 to the use point 14 is also substantially constant, and the deviation from the target temperature (75° C. in this case) is extremely small.

In the above description, although it is assumed that the temperature and flowrate of ultrapure water produced in the subsystem 4 are substantially constant, when the fluctuation range of this temperature or flowrate is large, the temperature and flowrate of the ultrapure water flowing through the pipe 5 may be detected by a sensor, and the temperature or flowrate of the warm water supplied to the heat source fluid path of the first heat exchanger 6 may be controlled accordingly.

In the present invention, a bypass line may be provided to return a part of the returned ultrapure water that is about to flow into the storage tank 16 from the pipe 7 or a part of the water stored in the storage tank 16 to the sub tank 2, bypassing the first heat exchanger 6. Furthermore, in the present invention, a discharge line may be provided to discharge a part of the returned ultrapure water that is about to flow into the storage tank 16 from the pipe 7 or a part of the water stored in the storage tank 16 to the outside of the warm ultrapure water production device.

The embodiment described above is an example of the present invention, and the present invention may have forms other than those shown in the drawings. For example, the pipe 11 may be provided with a device other than the UF membrane separation device 12. Further, the valve 23 may be a control valve whose opening degree may be controlled, but it may also be an automatic open/close valve whose opening/closing control adjusts the flowrate.

Although the present invention has been described in detail with reference to a particular embodiment, it is apparent to a person skilled in the art that various modifications can be made therein without departing from the spirit and scope of the present invention. The present application is based on Japanese Patent Application No. 2021-197028 filed on Dec. 3, 2021, which is incorporated herein by reference in its entirety.

### REFERENCE SIGNS LIST

2 Sub tank
4 Subsystem
6, 10, 21, 30 Heat exchanger
14 Use point
16 Storage tank

1. A warm ultrapure water production device, comprising:
an ultrapure water production portion, provided with a primary pure water production device and a secondary pure water production device;
an ultrapure water supply pipeline, supplying ultrapure water from the ultrapure water production portion to a use point;
a first heat exchanger provided in the ultrapure water supply pipeline, through which returned water that is not used at the use point is supplied as heat source water to a heat source fluid path via a returned water line;
returned water returning pipe, returning the returned water that has passed through the heat source fluid path of the first heat exchanger to the ultrapure water production portion; and
a heating means, further heating ultrapure water heated by the first heat exchanger,
wherein a warm pure water supply mechanism that supplies warm pure water in a midway of the returned water line is provided in a warm ultrapure water production device in which ultrapure water heated by the heating means is supplied to the use point.

2. The warm ultrapure water production device according to claim 1, wherein a storage tank is provided in the returned water line, and the storage tank is provided with the warm pure water supply mechanism.

3. The warm ultrapure water production device according to claim 1, wherein the heating means is a second heat exchanger using steam or warm water as a heat source.

4. The warm ultrapure water production device according to claim 1, wherein the warm pure water supply mechanism comprises a pure water supply pipeline communicating with a pure water supply source and a third heat exchanger provided in the pure water supply pipeline.

5. The warm ultrapure water production device according to claim 2, further comprising a temperature sensor that measures a temperature of water stored in the storage tank and a control means that controls the warm pure water supply mechanism so that a temperature detected by the temperature sensor is a prescribed temperature.

6. The warm ultrapure water production device according to claim 5, wherein the control means controls a supply amount of warm pure water supplied from the warm pure water supply mechanism so that a water level of the water stored in the storage tank falls within a prescribed range.

7. The warm ultrapure water production device according to claim 5, further comprising: a water feeding means that feeds the water stored in the storage tank at a fixed flowrate to the heat source fluid path of the first heat exchanger.

8. The warm ultrapure water production device according to claim 1, wherein the returned water returning pipe from the heat source fluid path of the first heat exchanger is provided with a cooling means that cools returned water.
